(19) United States
(12) Patent Application Publication
(10) Pub. No.: US 2004/0249644 A1
(43) Pub. Date: Dec. 9, 2004

(54) Method and structure for near real-time dynamic ETL (extraction, transformation, loading) processing

(75) Inventors: Josef Schiefer, White Plains, NY (US); Jun-Jang Jeng, Armonk, NY (US); Haifei Li, White Plains, NY (US); Henry Chang, Scarsdale, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/455,398

(22) Filed: Jun. 6, 2003

(51) Int. Cl. G06F 17/60

(52) U.S. Cl. 705/1

(57) ABSTRACT

A method (and structure) to automate business decisions by computer, including capturing an event predetermined to be relevant to a defined set of business decisions by computer. The event is automatically processed by the computer to extract, transform and enrich relevant data for the business decisions. The extracted relevant data is forwarded, immediately upon processing the event, to one or more appropriate decision making modules in the computer.

### BACKGROUND OF THE INVENTION

1. Field of the Invention

The present invention generally relates to a technique commonly known as extraction, transformation, loading (ETL) of event data for purposes of decision-support in a business or organization. More specifically, a near real-time processing method and structure, particularly useful in e-business environments and based on a software container concept, provides continuous monitoring, minimum latency for extracting decision-making information, and even a closed-loop capability.

2. Description of the Related Art

The widespread use of the Internet and related technologies in various business domains has accelerated the intensity of competition, increased the volume of data/information available, and shortened decision-making cycles considerably, especially in businesses that rely on e-business concepts. Consequently, strategic managers are being exposed daily to huge inflows of data and information from the businesses they manage and they are under pressure to make sound decisions promptly.

Typically, in a large organization, many distributed, heterogeneous data sources, applications, and processes have to be integrated to ensure delivery of the information required by decision makers. In order to support effective analysis and mining of such diverse, distributed information, a data warehouse (DWH) concept has evolved to collect data from multiple, heterogeneous (operational) source systems and to store integrated information in a central repository.

A decision-support data warehouse system, such as just mentioned, differs from an operational system commonly used in a business or organization to merely store transactional/operations data. An operational system is designed based upon recognizing that the operational patterns are known and are predictable. These systems assume a reliably predictable quantity and frequency of operational/transactional data will be recorded. Moreover, the amount of calculations for each transaction is well understood. Therefore, the computing resources, such as number of CPUs, CPU time, and amount of temporary memory and warehouse memory, can be reasonably predicted for transactional/operational systems.

In contrast, the purpose of a decision-support system, includes more than merely recording operational data. In a decision-support system, the input data will be evaluated by one or more algorithms for aspects related to decision-making. The demand upon a decision-making warehouse is unpredictable, since the nature of the evaluation cannot be predicted. That is, any specific input event, since its nature is unpredictable, might require only a simple algorithm for analysis (i.e., a small amount of computer resources), or it might require a complex analysis (i.e., a large amount of computer resources). Therefore, the amount of computing resources in a decision-making warehouse system is much less predictable than that in an operational system.

Since market conditions can change rapidly, it is becoming more important that up-to-date information be made available to decision makers with as little delay as possible. For a long time, it has been assumed that data in the data warehouse can lag at least a day, if not a week or a month, behind the actual operational data. This assumption was based on another underlying premise that strategic business decisions required a very rich historical data, not necessarily up-to-date information. That is, the traditional concept in decision-making information extraction has been oriented to a process thought to support primarily longer-term, strategic planning. In this conventional approach, data is analyzed periodically and managers eventually are notified of problems needing correction.

Existing ETL (extraction, transformation, loading) tools, therefore, typically rely on this assumption and achieve high efficiency in loading large amounts of data periodically into the data warehouse system. Traditionally, there is no real-time connection between a data warehouse and its data sources, because the write-once, read-many, decision-support characteristics conflict with the continuous update workload of operational systems. Thus, the conventional decision-making data warehouse has a poor response time.

Typically, batch data loading is done during frequent update windows, for example, every night. With this approach, the analysis capabilities of decision-support data warehouses are not affected. ETL approaches often take for granted that they are operating during a batch window and that they do not affect or disrupt active user sessions. While this still holds true for a wide range of data warehouse applications, the new desire for monitoring information about business processes in near real-time is breaking the long-standing rule that data in a data warehouse is static except during the downtime for data loading.

As the analytical capabilities and applications of e-business systems expand, providing real-time access to critical business performance indicators to improve the speed and effectiveness of business operations has become crucial. The decision making process in traditional data warehouse environments is often delayed because data cannot be propagated from the source system to the data warehouse in a timely manner.

### SUMMARY OF THE INVENTION

In view of the foregoing problems, drawbacks, and disadvantages of the conventional systems, it is an exemplary feature of the present invention to provide a method (and structure) in which a decision-making data warehouse system operates in near real-time, thereby minimizing latency time between capture of an event, evaluation of the event, and providing appropriate response as based on the evaluation.

It is another exemplary feature of the present invention to provide an ETL system based on the concept of a software container module that oversees the capture of events and the transformation and evaluation of the event data.

It is another exemplary feature of the present invention to provide a container-based ETL system in which the containers have available a multitude of standard services as infrastructure support, so that developers can focus on the logic of the evaluation rather than the development of service modules.

It is another exemplary feature of the present invention to provide a container-based, near real-time ETL system using the Java environment as a non-limiting preferred embodiment.

In a first exemplary aspect of the present invention, described herein is a method to automate business decisions by computer, including capturing an event predetermined to be relevant to a defined set of business decisions by computer. The event is automatically processed by the computer to extract, transform and enrich relevant data for the business decisions. This processing occurs essentially immediately upon the capturing. Extracted relevant data from the event, immediately upon processing, is automatically forwarded to one or more appropriate decision making modules in the computer. A computerized business decision is automatically rendered based upon the extracted relevant data from one or more captured events.

In a second exemplary aspect of the present invention, described herein is an extraction, transformation, loading (ETL) decision-support system, including a software container module to manage a lifecycle of each of a plurality of components in the container. The components are invoked for the purpose of extracting event data deemed relevant to a decision-making function of an organization, transforming the data, and loading the transformed data into a data store. The extracting, transforming, and loading occurs in a near real-time.

In a third exemplary aspect of the present invention, described herein is a computerized method of collecting data related to management decisions, including processing, in a near real-time, data from a captured event that is deemed relevant to a predefined set of management decisions. The processing includes at least one decision evaluation related to the predefined set of management decisions.

In a fourth exemplary aspect of the present invention, also described herein is an apparatus including an event adapter to extract events deemed relevant to a predefined set of management decisions into a standard format data, a processor to perform at least one of cleansing, matching, and transforming the data, calculating a metric from the data, and storing the metric, and an evaluator to evaluate at least one of the data and the metric as information related to at least one of the predefined set of management decisions. The evaluator performs the evaluation in a near real-time.

In a fifth exemplary aspect of the present invention, described herein is a method of operating an organization that includes at least one of: developing, for an organization, a computerized management-decision method of collecting data related to management decisions for the organization, wherein the computerized method includes processing, in a near real-time, data from a captured event deemed relevant to a predefined set of management decisions of the organization and the processing includes at least one decision evaluation; operating, for an organization, a near real-time system according to this method; transmitting a report or response to an organization or input source according to this method; receiving information derived from the method; and using information based on the method to assist in making one or more management decisions in said organization.

In a sixth exemplary aspect of the present invention, described herein is a signal-bearing medium tangibly embodying a program of machine-readable instructions executable by a digital processing apparatus to perform a computerized method of collecting data related to management decisions, the method including processing, in a near real-time, data from a captured event deemed relevant to a predefined set of management decisions. The processing includes at least one decision evaluation related to said predefined set of management decisions.

### BRIEF DESCRIPTION OF THE DRAWINGS

The foregoing and other features, aspects and advantages will be better understood from the following detailed description of an exemplary embodiment of the invention with reference to the drawings, in which:

FIG. 1 shows a container-based ETL (Extraction, Transformation, Loading) processing concept of the present invention;

FIG. 2 shows a continuous data integration process supported by the ETL container;

FIG. 3 shows an ETL environment, as exemplarily implemented in the J2EE (Java™ 2 Enterprise Edition) platform;

FIG. 4 shows a multithreading in the ETL container;

FIG. 5 shows a lifecycle and interface/classes of event adapters;

FIG. 6 shows a lifecycle and interface/classes of ETLets;

FIG. 7 shows a lifecycle and interface/classes of evaluators;

FIG. 8 shows an exemplary ETL solution deployment, using J2EE;

FIG. 9 illustrates an exemplary hardware/information handling system 900 for incorporating the present invention therein; and

FIG. 10 illustrates a signal bearing medium 1000 (e.g., storage medium) for storing steps of a program of a method according to the present invention.

### DETAILED DESCRIPTION OF AN EXEMPLARY EMBODIMENT OF THE INVENTION

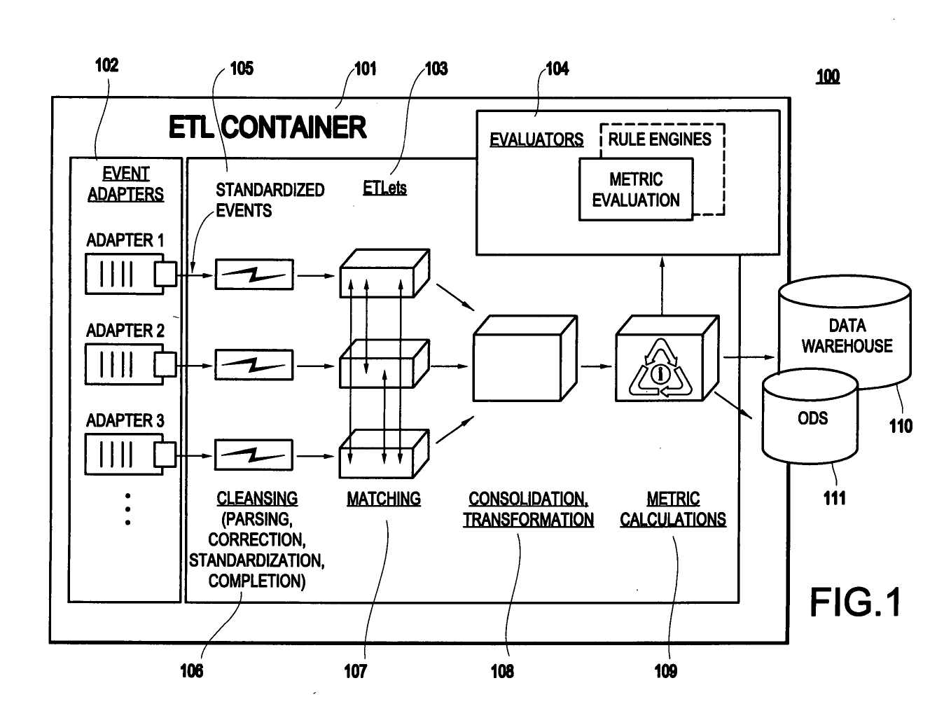

Referring now to the drawings, and more particularly to FIGS. 1 through 10, a preferred embodiment of the present invention will now be described. In the following discussion, the following terminology shall be intended.

“Near real-time” means minimal latency. In the context of near real-time data integration of the present invention, therefore, the data is integrated with minimal latency. Ideally, with the present invention, there is zero-latency between the moment that data has been extracted and the moment it is available/used for making business decisions.

“Automatic” or “automatically” means without human intervention. In the context of the container-managed environment described below, this terminology means that the container fully performs the function without requiring a user interaction.

“Subscribe” or “subscription” refers to a mechanism used to register interest in a certain type of data. One mechanism would be a matching-up of expressions used in a module which provide an output to be used as an input in a subsequent module.

“Light-weight” means a minimal overhead for conjoining and executing components. For example, the container-managed system described below has a container that processes each event by a Java™ thread (e.g., rather than a heavyweight operating system process), which approach minimizes the overhead for controlling and executing the managed component.

The Java™ 2 Enterprise Edition Platform (J2EE) has established itself as major technology for developing e-business solutions. This success is largely due to the fact that J2EE is not a proprietary product, but rather an open industry standard, developed as result of an industry initiative by large information technology companies. Many ETL solution vendors make their platforms J2EE compliant by extending their products with Java™ interfaces and J2EE connectors. Although these solutions can integrate J2EE components into the ETL processing, they cannot take full advantage of a J2EE Application Server with its middleware services, such as resource pooling, caching, clustering, failover, load-balancing, etc.

“Continuous” data integration aims to decrease the time it takes to integrate certain time-critical data and to make the information available to knowledge workers or software agents. This enables them to find out what is currently happening, decide on what should be done by utilizing the rich history of the data warehouse, and, therefore react faster to typical and abnormal data conditions for purposes of tactical decision support. It is noted that this goal differs from that of a longer-term, strategic approach mentioned above for conventional systems.

Continuous and near real-time data integration for data warehouses minimizes propagation delays from the operational source systems of an organization, which are responsible for capturing real world events. This improves timeliness by minimizing the average latency from the time a fact is first captured in an electronic format somewhere within an organization until the time it is available for knowledge workers who need it.

The present invention describes an architecture for a container-based ETL (extraction, transformation, loading) environment, which supports a continual, near real-time data integration with the aim of decreasing the time it takes to make business decisions and to attain minimized latency between the cause and effect of a business decision. Instead of using vendor proprietary ETL solutions, the present invention uses a novel approach, referred to herein as an ETL container, for managing ETL components which perform the ETL processing tasks.

It is noted that, although the following description refers to “business” operations and management, the present invention is not intended as being so limited. That is, the methods and concepts discussed herein are intended as applying equally to any organization, entity, or even private individual, for which management decisions are made as based on information received from one or more input sources adapted with a computer interface. The management decisions in most, if not all, organizations would benefit by the near real-time evaluation of input information and/or the automatic response to input information that the present invention provides.

As an exemplary preferred embodiment and shown beginning in FIG. 1, the present invention extends an existing J2EE Application Server to incorporate an ETL container 101 that enables a seamless integration with other J2EE containers and the utilization of all available middleware services of the application server. That is, somewhat similar to J2EE web applications where servlets and JSPs (Java™ Server Pages) take the place of traditional Common Gateway Interface (CGI) scripts, the approach of the present invention uses managed ETL components, referred to herein as “ETLets”, that replace traditional ETL scripts.

By extending a J2EE Application Server with this new ETL container 101, organizations are able to develop platform and vendor independent ETL applications the same way as traditional J2EE applications. In essence, developers are able to quickly and easily build scalable, reliable ETL applications and can utilize Java middleware services and reusable Java components provided by the industry. For example, EJB (Enterprise Java™ Beans) containers provide automated support for transaction and life cycle management of EJB components, as well as “bean” lookup and other services. Containers also provide standardized access to enterprise information systems (e.g., providing access to relational data through the JDBC API (Java™ Database ConnectivityApplication Program Interface).

In the present invention, near real-time dynamic ETL processing is achieved by using a container for managing ETL components. That is, the ETL container provides the services for the extraction, transformation, and loading of the data into a data warehouse. The container-based ETL processing system 100 shown in FIG. 1 preferably includes the following exemplary components.

The ETL Container

An ETL container 101 manages the lifecycle of the ETL components contained therein, and also provides services for the execution and monitoring of ETL tasks. There are three component types that are managed by the ETL container: 1) event adapters 102, 2) ETLets 103, and 3) evaluators 104.

Event adapters 102 extract or receive data from source system. The event adapter component 102 also unifies the extracted data in a standard XML (eXtensible Markup Language) format. ETLets 103 use the extracted XML data as input and perform the ETL processing tasks. ETLets also publish business metrics that can be evaluated by evaluator components 104.

FIG. 1 shows how these ETL components work together. Each of these components preferably implements a certain interface that is used by the ETL container in order to manage the components. The ETL container 101 automatically instantiates these components 102, 103, 104 and calls the interface methods during the components' lifetime.

Event Adapters

A purpose of event adapters 102 is to extract or receive data from source systems and to unify the different data formats. Event adapters translate all raw source data into a standardized event format 105. Event adapters can accept event data either asynchronously via messaging software or synchronously via a connector or resource adapter.

ETLets

After the dispatching of the standardized XML events in the event adapter 102, the ETL container 101 invokes appropriate ETLets 103 which have subscribed to the event. The term “subscribed to” means that an ETLet has been programmed to “have an interest in” the event as it is received. As shown later, ETLets 103 can run in multiple threads in parallel. The ETL container 101 manages three types of ETLets: event-driven ETLets, scheduled ETLets, and exception ETLets.

ETLets 103 implement the ETL processing tasks which can include data cleansing 106, data matching 107, data transformation 108, the calculation of business metrics 109, and storing the metrics in a database table 110, 111. ETLets can also publish the business metrics to allow the container to pass these metrics to the evaluator components 104 that have subscribed to the metrics.

FIG. 1 shows two storage devices, the data warehouse 110 and the Operational Data Store 111. The data warehouse 110 would typically be a large (e.g., gigabytes or terabytes) data storage and is used in the present invention to store and provide large amounts of data, similar to conventional systems. However, such large data storage may be too slow for a near real-time system.

Therefore, the present invention may be implemented to have a second, smaller memory, the Operational Data Store 111 for quick access of smaller amounts of data. However, other configurations, such as an extremely fast, parallel data warehouse memory would be possible, albeit more expensive.

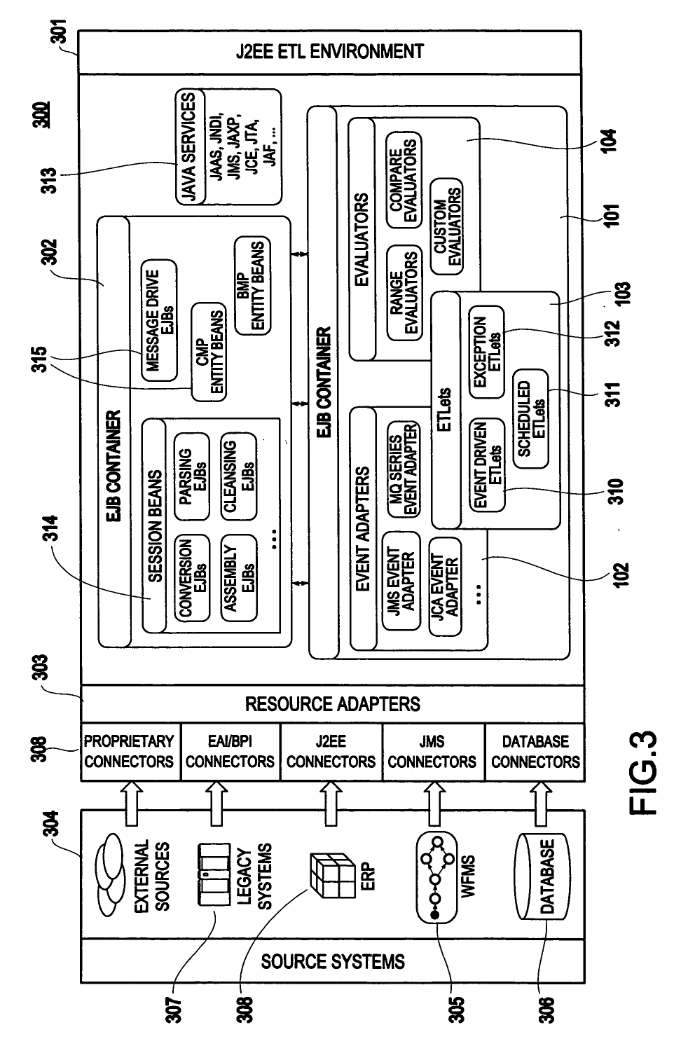

As perhaps better seen in FIG. 3, the ETLet 103 can exemplarily, be broken down into three types, as follows. First, event-driven ETLets 310 can subscribe to a number of standardized events that are provided by the event adapters and that are relevant to the ETL processing logic.

Second, scheduled ETLets 311 are triggered by the ETL container in intervals at specific points in time. The schedule for the triggering is also configurable in the deployment descriptor of the ETLet. Scheduled ETLets can be used to perform recurring ETL tasks, for instance aggregating the daily order data after a business day.

Third, Exception ETLets 312 are a special kind of ETLets that are invoked when an exception is placed within an ETLet of the ETL application and this exception cannot immediately be handled by the ETLet itself. This might happen, for instance, if a manual step or input is required in order to resolve the problem of the exception. Exception ETLets are used to store these exceptions and the triggering events that caused the exception in a file or database for a later manual correction of the problem.

Exception ETLets can also be used for sending out notifications. For instance, an administrator can be notified via email that an unhandled exception occurred in an ETL container. Exception ETLets should preferably also be defined in the deployment descriptor (to be described below).

Evaluators

The metrics calculated and published by ETLets 103 can be evaluated by evaluator components 104. An evaluation of calculated business metrics is very valuable because it can be used to create an intelligent response (e.g., sending out notifications to business people or triggering business operations) in near real-time. Evaluators can be either implemented by developers or act as proxies by forwarding the evaluation requests to rule engines for more sophisticated evaluations.

Continuous Data Integration with the ETL Container

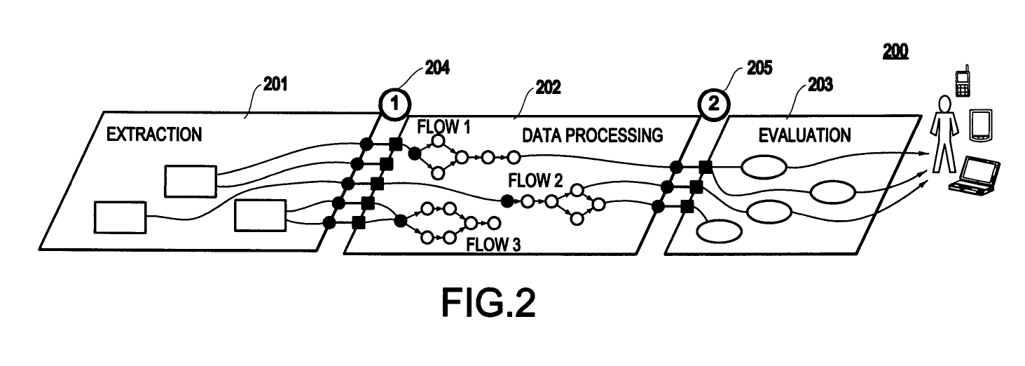

Near real-time data integration manages continuous data flows from transactional systems and performs the incorporation to a data warehouse 110, 111. FIG. 2 shows the process 200 for continuously integrating data from various source systems. The processing steps are not equivalent to the traditional ETL because the underlying assumptions for the data processing and the latency requirements are different.

That is, as mentioned earlier, traditional ETL tools often take for granted that they are operating during a batch window and that they do not affect or disrupt active user sessions. If data is integrated continuously, a permanent stream of data would be integrated into the data warehouse environment while users are using it. The data integration process is performed in parallel with complex data processing and, therefore, differs from traditional batch load data integration. It should use regular database transactions (i.e. generating inserts and updates on-the-fly), because, in general, database systems do not support block operations on tables while user queries simultaneously access these tables.

Moreover, the data rate of continuously integrated data is usually low, with an emphasis on minimized latency for the integration. In contrast, bulk loading processes buffer detests in order to generate larger blocks, and, therefore, the average latency for data integration with bulk loading increases. Data integration based on frequent bulk loads can exceed the data latency requirements.

FIG. 2 shows three stages 200 for continuous data integration supported by the ETL container: extraction 201, data processing 202, and evaluation 203. The ETL container 101 does not have a separate loading stage for the ETL processing, since data is not buffered and prepared for bulk loading.

Instead, the ETL container concept extends the traditional data integration process with an evaluation stage 203 that allows reacting on newly integrated data. An evaluation of calculated business metrics can be very valuable because it can be used to create an intelligent response (e.g., sending out notifications to business people or triggering business operations) in near real-time.

As shown in FIG. 2, the ETL container 101 provides the following functionality to support the continuous data integration process.

First, there is the function of receiving and extracting 201 source data with event adapters 102. Permanently integrating data from various operational sources addresses the timeliness issue by minimizing the average latency from when a fact is first captured in an electronic format somewhere within an organization until it is available for the knowledge worker who needs it.

In general, not all data (i.e., only a relatively small amount of data), represents transactions or other relevant information that must be captured continuously and “live” from transactional systems to be integrated in near real-time with the historical information in the data warehouse. The ETL container 101 is able to accept real-time feeds with transactional key business data via an asynchronous messaging infrastructure or synchronous connectors. The ETL container 101 uses event adapters 102 to extract or receive data from various source systems and to unify the extracted data into a standard event format.

Second, extraction components (i.e., event adapters 102) and data processing components (i.e., ETLets 103) are bound together (see label 204 in FIG. 2). That is, ETLets 103 can subscribe to event data that was extracted with event adapters 102. The ETL container 101 automatically invokes all ETLets 103 which are subscribed to an incoming event.

Third, ETLets 103 perform data processing 202. Continuous data streams use a light-weight data processing of the events that were raised in the source system and propagated in near real-time to the data warehouse 110,111 environment.

The data processing step 202 can include any type of data transformation 108, data cleansing 106, the calculation of business metrics 109, and storing the metrics in a database table 110, 111. The ETL container 101 streamlines and accelerates the data processing by moving data between the processing steps that are implemented as ETLets without any intermediate file or database storage.

In contrast, traditional (i.e., batch-oriented) ETL scripts are not suitable for an event-driven environment where data extracts and data transformations are very small and frequent because the overhead for starting the processes and combining the processing steps can dominate the execution time. Another limitation of ETL scripts is that they are written for a specific task in a self-sustaining manner and do not provide any kind of interfaces for data inputs and outputs. Because of this constraint in the traditional approach, data processing environment must be very light-weight and scalable to handle a large number of processing flows.

The ETL container 101 and ETLets 103 of the present invention provide the capabilities to overcome these limitations of ETL scripts.

Fourth, the data processing components (i.e., ETLets 103) and evaluation components (i.e., evaluators 104) are bound together (see label 205 in FIG. 2). That is, evaluators 104 can subscribe to business metrics that are generated by the ETLet components 103. The ETL container 101 passes the generated metrics to the evaluators 104.

Fifth, evaluators 104 evaluate business metrics. The monitoring of business operations often entails a direct or indirect feedback to operational systems. This response can be done manually or automatically and enhances the operational system with business intelligence. This is usually referred to as “closed loop analysis”. In the case where an automatic response or notifications is desired, the evaluator components 104 of the ETL container 101 can evaluate the integrated data on-the-fly, and can trigger business operations based on the results of the evaluation.

Preferred Embodiment using the J2EE Platform

As a non-limiting preferred embodiment of the present invention, FIG. 3 shows a J2EE (Java™ 2 Platform, Enterprise Edition) architecture 300 for a container-based ETL environment 301 which enables a continuous integration of data from various source systems 304 in near real-time. J2EE environments have containers (e.g., 101, 301) which are standardized runtime environments that provide specific services 313 to the components.

Components can expect these services 313 to be available on any J2EE platform from any vendor. For example, EJB (Enterprise Java™ Beans) containers 302 provide automated support for transaction and life cycle management of EJB components, as well as bean lookup and other services 314, 315. Containers also provide standardized access to enterprise information systems 313, such as providing access to relational data through the JDBC API (Java™ Database ConnectivityApplication Program Interface).

As FIG. 3 shows, in the preferred embodiment 300, an existing J2EE environment 301 is extended with an ETL container 101 which provides services for a continuous data integration into a data warehouse. The ETL container 101 is a robust, scalable, and high-performance data staging environment, which is able to handle a large number of data extracts or messages from various source systems in near real-time. It takes responsibility for system-level services, such as threading, resource management, transactions, security, persistence, and so on, which are important for the ETL processing.

The ETL container 101 is responsible for the monitoring of the data extracts and transformations, and ensures that resources, workload, and time-constraints are optimized. ETL developers are able to specify data propagation parameters (e.g., schedule and time constraints) in a deployment descriptor and the container will try to optimize these settings. This arrangement leaves the ETL developer with the simplified task of developing functionality for the ETL processing tasks. It also allows the implementation details of the system services to be reconfigured without changing the component code, making components useful in a wide range of contexts.

With the present invention, instead of developing ETL scripts, which are often hard to maintain, scale, and reuse, ETL developers are able to implement reusable components 101,302 for ETL processing.

This concept is further extended by the present invention by adding new container services, which are useful for the development and execution of ETL applications. Examples of such container services are a flow management service which allows a straight-through processing of complex ETL processes, or an evaluation service which significantly reduces the effort for evaluating calculated business metrics.

FIG. 3 shows the architecture 300 of a J2EE ETL environment with an ETL container 101, an EJB container 302, and various resource adapters 303.

EJB containers 302 enhance the scalability of ETL applications and allow the distribution of the ETL processing on multiple machines. EJB containers 302 manage the efficient access to instances of the EJB components regardless of whether the components are used locally or remotely. ETL developers can write EJB components for typical ETL processing tasks (data cleansing, data parsing, complex transformations, assembly of data, etc., see item 314) and can reuse these components in multiple ETL applications.

J2EE environments have a multi-tiered architecture, which provides natural access points for the integration with existing and future source systems. The integration tier (in J2EE environments, the integration tier is also called “enterprise information tier”) is crucial for an ETL environment, because it contains data and services also for non-J2EE resources 313 that can be utilized for the data extraction from source systems 304. Workflow management systems 305, databases 306, legacy systems 307, ERP (Enterprise Resource Planning) 308 and EAI (Enterprise Application Integration) systems, and other existing or purchased packages reside in the integration tier. A J2EE ETL environment provides a comprehensive set of resource adapters 303 for these source systems 304.

For instance, the J2EE platform includes a set of standard Application Program Interfaces (APIs) for high-performance connectors 308. Many vendors of ERP or CRM (Customer Relationship Management) systems (e.g., SAP, Oracle) offer a J2EE connector interface for their systems.

With the architecture of the present invention, ETL developers can reuse existing high-performance J2EE connectors and connectors of EAI solutions for the data extraction without worrying about issues like physical data formats of source systems, performance or concurrency. Moreover, the J2EE platform includes standard APIs for accessing databases (e.g., Java™ Database Connectivity, JDBC) and for messaging (e.g., Java™ Messaging Service, JMS) which enables the ETL developers to access queue-based source systems that propagate data via messages.

Extracting Data with Event Adapters

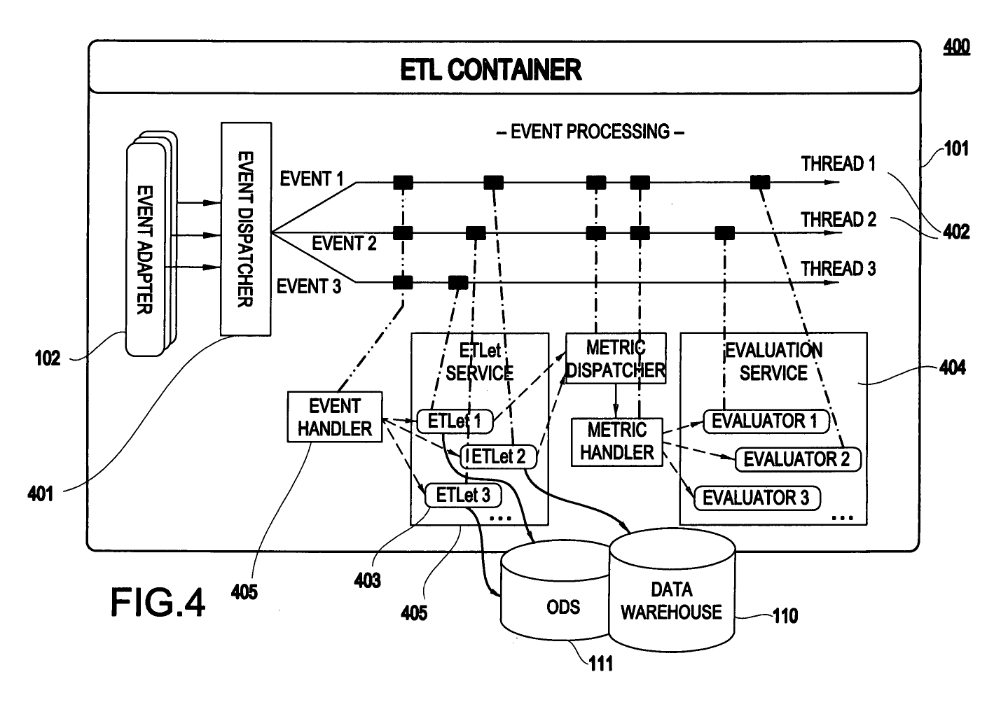

FIG. 4 illustrates the ETL 101 as having event adapters 102 receiving and dispatching events via an event dispatcher 401, which assigns threads 402 for the ETL processing with ETLets 403 and evaluators 404. The components shown with rounded boxes 403,404 are the ETL components that are managed by the container 101 and are implemented by the ETL developers. The components shown with square boxes (e.g., 401, 404, 405) are internal container components-that are used to conjoin all ETL components. These internal components are shown only for illustration purposes. The ETL developers never see or have to deal with these internal components.

A purpose of event adapters 102 is to extract or receive data from source systems and to unify the different data formats. Event adapters translate raw source data into an XML event format with a defined XML schema. Event adapters can accept event data synchronously via messaging software, or also synchronously via a resource adapter (e.g., JDBC or J2EE connector, as shown in FIG. 3). The first option is more scalable because it completely decouples the event source, such as a WFMS (Workflow Management System), from the event processing in the ETL container. Event adapters are running on their own threads and can receive and dispatch events in parallel.

In order to address overload situations, where not enough resources are available to instantiate ETLets for the event processing, the ETL container 101 can block an event adapter temporarily. For instance, if there is no thread available for the processing of an incoming event within a specified time-out period, the event adapter 401 is notified of the overload situation and can react to this situation individually.

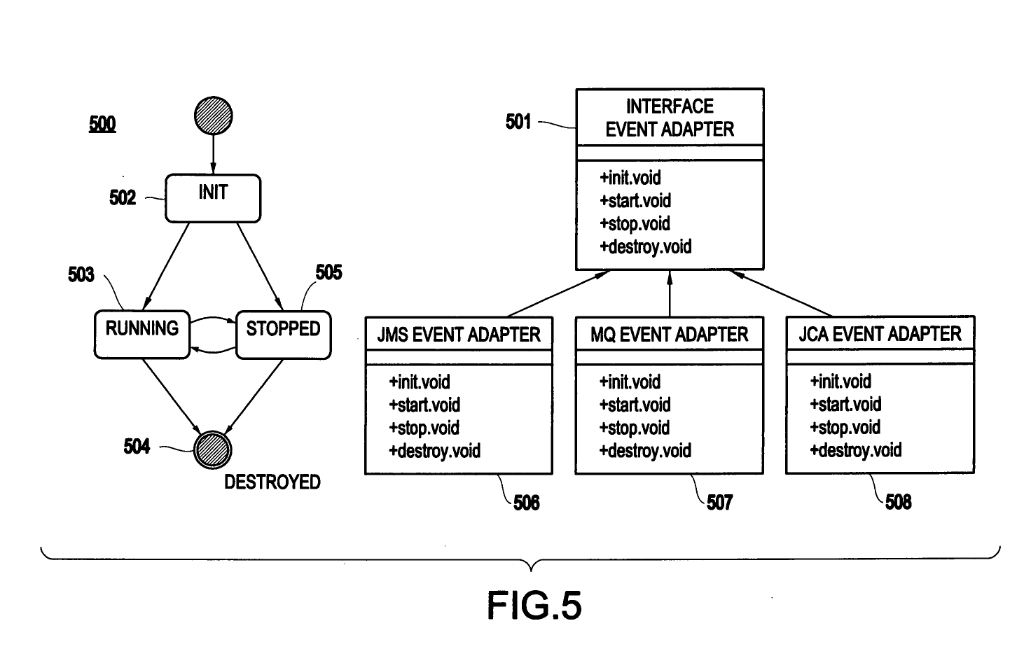

FIG. 5 shows a lifecycle 500 and interface/classes 501 of event adapters 102. All ETL components preferably include an init state 502, running state 503, and destroyed state 504. The event adapters 102 have an additional stopped state 505, which enables the ETL container 101 to stop the event processing.

When the container 101 starts an event adapter 102, it does so by invoking the init method 502 and thereafter invokes the appropriate method 503, 504, 505 to, for example, run, destroy, or stop the event adapter 102.

An example of the event adapter interface 501, as implemented in Java, is shown to the right of the life cycle 500. Bound to the exemplary event adapter 501 would be one or more services available from Java™. FIG. 5 shows three such services: Java™ Messaging Service Event Adapter (JMSEventAdapter) 506 is a J2EE event adapter that responds to Java™ messages. MQEventAdapter 507 is an event adapter for IBM Websphere MQ—an IBM messaging software—see also http://www-3.ibm.com/software/integration/wmq/ and JCAEventAdapter 508 is an event adapter as defined by JCA=J2EE Connector Architecture, see also http://java.sun.com/j2ee/connector.

ETL Processing with ETLets

After the dispatching of the standardized XML events in the event adapter, the ETL container 101 invokes ETLets 103 which have subscribed to the event. In order to achieve a high performance level, the ETL container 101 uses a thread pool whose size is adjustable. ETLets 103 run in multiple threads in parallel. However, all processing steps of an ETL processing flow usually run within the same thread.

For one event type (e.g., ACTIVITY_STARTED events), there can be several ETLets that have subscribed to the same event type. In this case, the ETL container 101 will invoke the subscribed ETLets 103 in parallel.

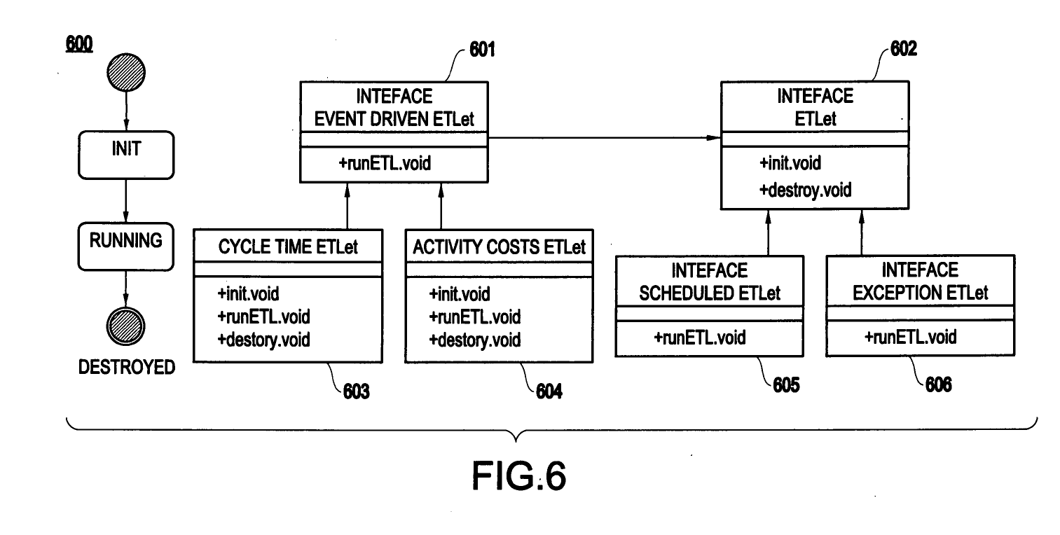

A lifecycle 600 of an ETLet is shown in FIG. 6. The ETLet components implement one of the ETLet interfaces 601, 605 and 606. These three interfaces share a super interface 602 with common methods. Examples for an implementation of the EventDrivenETLet interface are a CycleTimeETLet 603 class for the calculation of cycle times of business processes, or ActivityCostsETLet 604 class for the calculation of costs for business activities

All ETL types have a runETL( ) method with a different signature. ETL developers implement this method with the ETL processing logic. This processing logic can include data transformation, the calculation of business metrics, and the storage of the metrics in a database table. ETLets can also publish the business metrics to allow the container to pass these metrics to the evaluator components that have subscribed to the metric type.

ETLets are highly reusable components because 1) they are configurable via the deployment descriptor, 2) they receive the incoming data as standardized XML events and are therefore independent from the data formats of the data sources, and 3) existing ETLets can be easily extended via class inheritance.

Traditional WFMS are suitable to control the execution of ETL batch-processes. However, when it comes to continuous data integration, a very large amount of ETL process instances will arise because the incoming events are processes individually and have to be handled by a separate flow. For instance, several thousand order process instances can result in potentially millions of workflow events.

Therefore, it is not feasible to use traditional workflow engines for managing millions of ETL processing flows. As an alternative, a solution is needed that is extremely lightweight and supports sufficient capabilities to control the ETL processing flows.

For the control of the ETL process, the ETL container 101 uses ETLet triggers that define conditions for the execution of an ETLet. These conditions are checked at different points in time of the ETL processing.

The current ETL container implementation supports the following triggering conditions:

1. Schedule

An ETLet can have a triggering schedule. Between predefined start and the end timestamps, the scheduler triggers the associated ETLet. The frequency of triggering an ETLet is defined by a time interval.

2. Event-ID or XPath Selector

ETLets can be triggered if an incoming event has a particular event-ID or a matching XPath expression. The matching of incoming events with XPath expressions allows a content-based subscription to XML events (e.g., subscription to all events that include an order business object). This subscription mechanism is more flexible than traditional queue topic subscription mechanisms.

3. ETLet Processing Outcome

The ETL container can trigger ETLets after a successful or failed execution of another ETLet, or independently from the execution result of the ETLet. This triggering mechanism can be used to construct ETL processing flows (e.g., ETLet chaining).

4. Evaluation Result

An ETLet can also be triggered based on the outcome of a metric evaluation. For instance, if a metric reaches a certain threshold it could be an indicator that additional ETL processing is required.

Evaluation of Business Metrics with Evaluators

The metrics calculated and published by ETLets can be evaluated by evaluator components. An evaluation of calculated business metrics can be very valuable because it can be used to create an intelligent response (e.g., sending out notifications to business people or triggering business operations) in near real-time.

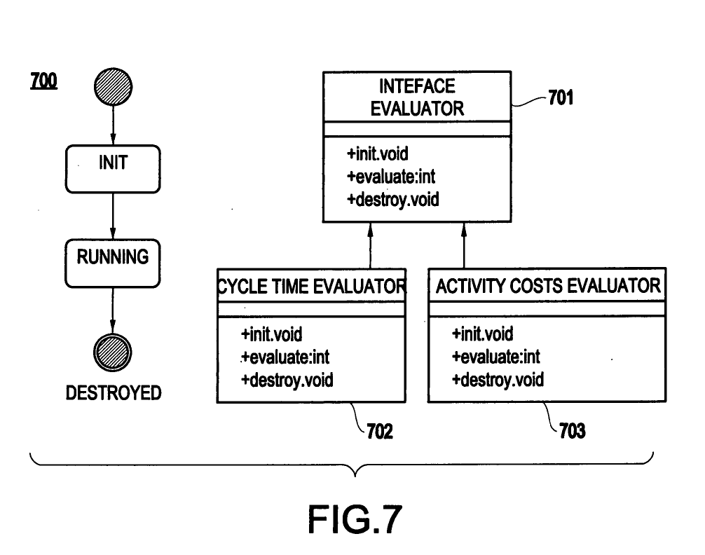

As shown in FIG. 7, evaluators 104 have the same lifecycle 700 as shown in FIG. 6 for ETLets. The evaluator 104 can be either implemented by ETL developers or act as proxies by forwarding the evaluation requests to rule engines for more sophisticated evaluations. In the first case, ETL developers have to implement the evaluate( ) method of the Evaluator interface 701 with the evaluation logic. Examples for an implementation of the Evaluator interface 701 are a CycleTimeEvaluator 702 class for evaluating the cycle times of a business process, or an ActivityCostsEvaluator 703 class for the evaluation of business activity costs. An evaluator can subscribe to a set of metric types that are defined in the deployment descriptor. For the subscription to metric types, there are two mechanisms available. First, evaluators can subscribe to a set of metric types independent from ETLets that generate the metrics. Second, evaluators can subscribe to the metric types of a defined set of ETLets.

Deployment of an ETL Application

The J2EE platform allows ETL developers to create different parts of their ETL applications as reusable components. The process of assembling components into modules and modules into ETL solutions is called packaging. The process of installing and customizing the ETL components in an operational environment is called deployment.

The J2EE platform provides facilities to make the packaging and deployment process simple. It uses JAR (Java™ archive) files as the standard package for modules and applications, and XML-based deployment descriptors for customizing components and applications. Although deployment can be performed directly by editing XML text files, specialized tools best handle the process.

EJB and Web containers also use deployment descriptors for the configuration of components and applications (see http://www.theserverside.com/resources/articles/J2EE-Deployment/chapter.html). However, the ETL deployment descriptor is tailored to ETL applications.

An example of Sun's deployment tool is: http ://wwws.sun.com/software/sundev/previous/ffj/j2eedev-sch.html

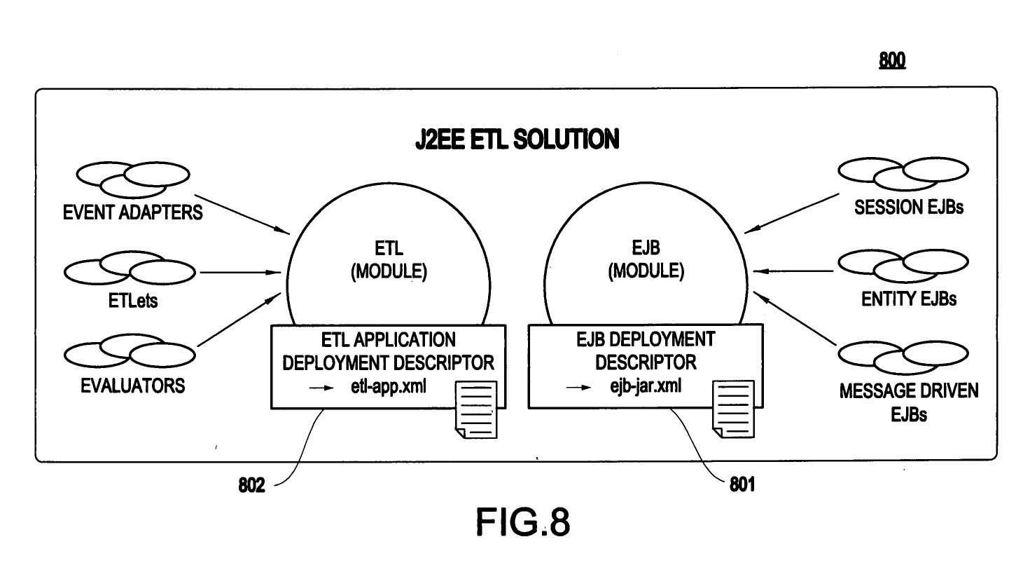

As shown in FIG. 8, for the packaging and deployment of an ETL solution, two types of deployment descriptors are used for the modules.

EJB Deployment Descriptors (ejb-jar.xml)

An EJB deployment descriptor 801 provides both the structural and application assembly information for the EJBs that are used in the ETL application. The EJB deployment descriptor is a part of the J2EE platform specification.

ETL Application Deployment Descriptor (etl-app.xml)

The deployment descriptor 802 for ETL applications lists all ETL components (event adapters, ETLets, evaluators) and specifies the configuration parameters for these components. This includes general configuration information about the ETL application and ETL components (e.g., name, description, etc.), the implementation classes for the ETL components, data propagation parameters for the event adapters (e.g., connection parameters, etc.), configuration and ETL processing parameters for ETLets (e.g., triggers, published metrics, etc.), and evaluation parameters for evaluators (e.g., evaluation thresholds).

During the deployment, the deployment team adapts the deployment descriptor settings to an existing data warehouse environment. In order to deploy the present invention, a specialized tool could be used. Alternatively, there is a standard deployment API for J2EE (see http://java.sun.com/j2ee/tools/deployment/). The deployment of applications for the ETL container would be very similar to the deployment of traditional J2EE applications and therefore, it would follow this process. Moreover, it is also possible to perform the deployment manually and edit the deployment descriptor with an XML editor.

ETL applications can be divided into modules which include a set of event adapters, ETLets, or evaluators. A module has a separate deployment descriptor for the configuration of the components within the module. There are three ways of packaging event adapter, ETLets and evaluator components: 1) each component is put into a separate module, 2) several components are packaged into one module, and 3) all application components are packaged into one single module. The decision on which packaging strategy is most appropriate depends on the application size and the deployment requirements.

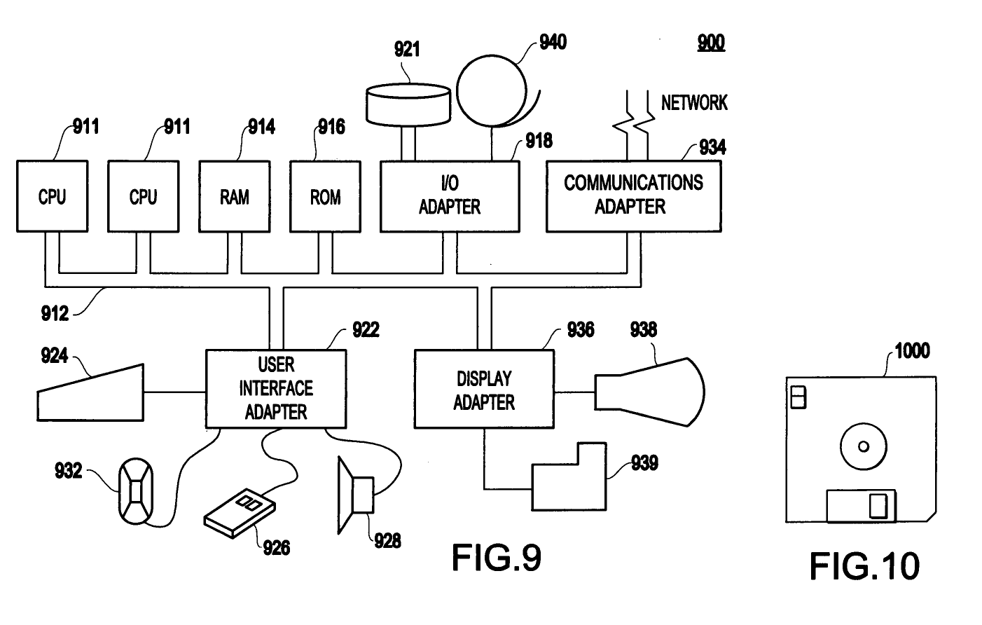

FIG. 9 illustrates a typical hardware configuration of an information handling/computer system in accordance with the invention and which preferably has at least one processor or central processing unit (CPU) 911.

The CPUs 911 are interconnected via a system bus 912 to a random access memory (RAM) 914, read-only memory (ROM) 916, input/output (I/O) adapter 418 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 939 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 911 and hardware above, to perform the method of the invention.

This signal-bearing media may include, for example, a RAM contained within the CPU 911, as represented by the fast-access storage for example. Alternatively, the instructions may be contained in another signal-bearing media, such as a magnetic data storage diskette 1000 (FIG. 10), directly or indirectly accessible by the CPU 911.

Whether contained in the diskette 1000, the computer/CPU 911, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

The ETL container can be used in various environments. The present invention uses the ETL container for the processing of events from business processes. In this context, the ETL container is used as a component for solutions for business process/activity monitoring.

However, other applications of the ETL container can easily be imagined, such as:

Processing of Web events (events about user behavior on websites (e.g., user puts something into the shopping cart or presses the search button)

Processing of Network events (e.g., events about network failures)

Processing of Application events or Operating System events (e.g., events about starting/stopping/failing services or applications)

Processing of Biosurveillance/Crime events (e.g., events that show a pattern of terrorists)

Processing of events in the financial industry (e.g., stock trades, stock price changes etc., suspicious account transactions)

Processing of Environmental events (e.g., events about weather changes, hurricanes, etc.)

The present invention provide a method and structure in which a decision-making data warehouse system operates in near real-time, thereby minimizing latency time between capture of an event, evaluation of the event, and providing appropriate response as based on the evaluation. The ETL system of the present invention is based on the concept of a software container module that oversees the capture of events and the transformation and evaluation of the event data.

The containers of this exemplary container-based ETL system have available a multitude of standard services as infrastructure support, so that developers can focus on the logic of the evaluation rather than the development of service modules, and is exemplarily implemented in the Java environment.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A computer-implemented method to automate business decisions, said method comprising:
capturing an event predetermined to be relevant to a defined set of business decisions;
processing the event to extract and transform relevant data for the business decisions, said processing occurring upon said capturing; and
forwarding, upon said processing the event and in near real-time, the extracted relevant data to one or more appropriate decision-making modules.

2. The method of claim 1, wherein a container-managed environment manages and executes said capturing, said processing, and said forwarding.

3. The method of claim 1, further comprising:
automatically rendering a computerized business decision based upon extracted relevant data from one or more captured events.

4. The method of claim 1, wherein the decision making modules are utilizable for at least one of an automatic response to source systems and sending a notification with minimal latency.

5. The method of claim 1, wherein extracted data is unified into a standardized data format after the data extraction, and
wherein the standardized, extracted data comprises an input for the processing the event.

6. The method of claim 1, wherein the processed data is unified into a standardized data format after the processing and the standardized, processed data comprises an input for the decision-making modules.

7. The claim in method 1, wherein said forwarding the extracted relevant data comprises a subscription process including a matching of expressions.

8. The method of claim 1, wherein said forwarding the extracted relevant data to appropriate decision-making modules comprises a subscription process including a matching of expressions.

9. The method of claim 1, wherein said capturing and said processing are executed in near real-time to minimize latency between a cause and an effect of a business decision.

10. The method of claim 2, wherein container-managed components are platform-independent and are deployable in a plurality of data warehouse environments.

11. The method of claim 2, further comprising:
establishing a container, said container including:
a data extraction unit;
a data processing unit; and
a decision making unit,
wherein a lifecycle of said data extraction unit, a lifecycle of said data processing unit, and a lifecycle of said decision making unit are managed by said container.

12. The method of claim 11, wherein the container further provides services for the data extraction, data processing and decision-making that are utilizable by the container-managed components.

13. The method of claim 11, wherein the container enables a direct processing and decision-making of extracted data without using an intermediary storage.

14. The method of claim 11, wherein the container monitors and manages the components by optimizing a setting specified in a deployment descriptor of said container-managed environment.

15. The method of claim 14, wherein each said container-managed component is configurable via a deployment descriptor, said deployment descriptor being used for at least one of:
defining and registering new components;
reconfiguring existing components; and
resolving external dependencies of the container-managed components.

16. The method of claim 11, wherein the container uses a multithreading and a light-weight flow management for the data extraction, data processing, and decision-making, such that a processing of a plurality of any of data extracts and messages is performable concurrently in near real-time.

17. The method of claim 11, wherein the container provides a separation of extraction logic, transformation logic, and decision-making logic, and wherein the container-managed components are pluggable and extendible.

18. The method of claim 11, wherein the container coordinates the processing and conjoins extraction components, transformation components, and decision-making components.

19. The method of claim 11, wherein the container enables a development of a predetermined solution that is extendible and customizable.

20. The method of claim 19, wherein the predetermined solution comprises at least one of:
a component level;
a module level; and
a solution level.

21. An extraction, transformation, loading (ETL) decision-support system, comprising:
a software container module to manage a lifecycle of each of a plurality of components in a container, said components being invoked for a purpose of:
extracting event data deemed relevant to a decision-making function of an organization;
transforming said data; and
loading said transformed data into a data store,
wherein said extracting, transforming, and loading together occur in near real-time.

22. The ETL decision-support system of claim 21, wherein said container includes:
an evaluator component that receives said data and that automatically provides a decision information as an output.

23. The ETL decision-support system of claim 22, wherein said container further comprises:
an event capture component that receives said event data; and
a processing component that receives an output from said event capture component.

24. The ETL decision-support system of claim 23, wherein said container is implemented in a Java™ 2 Enterprise Edition Platform (J2EE) environment.

25. A computerized method of collecting data related to management decisions, said method comprising:
processing, in near real-time, data from a captured event, said event deemed relevant to a predefined set of management decisions,
wherein said processing includes at least one decision evaluation related to said predefined set of management decisions.

26. An apparatus, comprising:
an event adapter to extract events deemed relevant to a predefined set of management decisions into a standard format data;
a processor to perform at least one of cleansing said data, matching said data, transforming said data, calculating a metric from said data, and storing said metric; and
an evaluator to evaluate, in near real-time, at least one of said data and said metric as information related to at least one of said predefined set of management decisions.

27. The apparatus of claim 26, wherein said event adapter, said processor, and said evaluator comprise components in a software container and
wherein said container manages a lifecycle of each of said components.

28. A method of operating an organization, said method comprising at least one of:
developing, for an organization, a computerized management-decision method of collecting data related to a management decision for said organization, wherein said computerized method comprises processing, in a near real-time, data from a captured event, said event deemed relevant to a predefined set of management decisions of said organization and said processing includes at least one decision evaluation;
operating, for an organization, a near real-time system according to said method;
transmitting a report or response to an organization or input source according to said method;
receiving information derived from said method; and
using information based on said method to assist in making one or more management decisions in said organization.

29. A signal-bearing medium tangibly embodying a program of machine-readable instructions executable by a digital processing apparatus to perform a computerized method of collecting data related to a management decision, said method comprising:
processing, in near real-time, data from a captured event, said event deemed relevant to a predefined set of management decisions, wherein said processing includes at least one decision evaluation related to said predefined set of management decisions.

30. A method of improving responsiveness of automated business decisions to one or more relevant events, said method comprising:
capturing, by a computer, an event predetermined to be relevant to a defined set of business decisions;
processing, by said computer, the event to extract and transform relevant data for the business decisions, said processing occurring upon said capturing;
forwarding, upon said processing the event, the extracted relevant data to one or more appropriate decision-making modules in said computer; and
automatically rendering a computerized business decision based upon extracted relevant data from one or more captured events.
